(19) United States
(12) Patent Application Publication
(10) Pub. No.: US 2010/0140576 A1
(43) Pub. Date: Jun. 10, 2010

(54) Warning System For Hydraulic Lifting Apparatus

(76) Inventor: Victor Hung, Taipei City (TW)

Correspondence Address: LATHROP & GAGE LLP, 2345 GRAND Boulevard, SUITE 2400, KANSAS CITY, MO, 64108, US

(21) Appl. No.: 12/611,651

(22) Filed: Nov. 3, 2009

Related U.S. Application Data
(60) Provisional application No. 61/110,741, filed on Nov. 3, 2008.

(51) Int. Cl. B66F 17/00; G08B 21/00; B66F 3/24; B66F 3/42

(52) U.S. Cl. 254/93 R

(57) ABSTRACT

The disclosed subject matter provides a warning system for overloads in hydraulic jacking and lifting structures, that provides a warning to the user sufficiently prior to an actual overload condition. The overload or potential overload is detected from fluid pressures of the fluid displaced from the pump of the jacking or lifting structures.

### RELATED APPLICATION

This application claim priority to U.S. Provisional Patent Application Ser. No. 61/110,741, filed Nov. 3, 2008, the disclosure of which is incorporated herein by reference.

### TECHNICAL FIELD

The disclosed subject matter relates to a safety device for hydraulic jacks, particularly to separate overload detecting and warning systems disposed in the hydraulic jack for ensuring safe operating conditions.

### BACKGROUND

Hydraulic jacks are widely used in lifting operations for ordinary mechanical work. It is of critical importance that these hydraulic jacks operate safely and without failure, to avoid damage or loss of life and property. To this effect, hydraulic jacks are equipped with emergency relief valves, that open once a predetermined pressure has been reached in the high pressure line, allowing fluid to flow from the high pressure line to a low pressure reservoir, relieving the dangerous situation in the high pressure line. Relieving the dangerous high pressure prevents failures of the high-pressure cylinder as a result of unlimited rise of the pressure applied thereto.

However, even with the safety limit marked on the conventional hydraulic jack for ensuring safe operation, some users take a hydraulic jack with a small capacity to perform the lifting operation requiring a greater capacity. The problem is that: (1) the user cannot exactly estimate the weight of the load; and (2) while the overload condition is developing on the hydraulic jack, no warning indication is given to the user. Moreover, as the conventional safety valves are outside of the high-pressure cylinder, when the load on the hydraulic jack is suddenly increased (such as a worker casually climbing onto the load), a hazardous high pressure will be abruptly produced in the high pressure cylinder. In this case, the abnormal sudden high pressure cannot be relieved, but also, the worker operating the jack is not aware of this dangerous situation.

Additionally, many times the worker simply attempts to lift a load beyond the capability (capacity or lifting capacity) of the hydraulic jack. Jack performance in such instances may begin normal, but soon, lifting becomes slow or nonexistent. Accordingly, the user may believe that the jack is not performing properly, while in reality, the jack has simply exceeded its lifting capacity and needs to be reset.

Furthermore, once the high pressure situation is relieved, the jack may be returned to the point of purchase, as inoperable, when in fact, the jack was fully operable, it just exceeded its load limit. These returned units must either be remanufactured, and sold at a discount, or simply, discarded, when, had the user been aware of their improper operation, the return never would have occurred. This results in the loss of business for the manufacturer, through the costs associated with the return, and more important, the loss of goodwill, from what is mistakenly believed to be a non-performing or underperforming jack.

### SUMMARY

The disclosed subject matter provides a warning system for overloads, also known as overload conditions (these terms are used interchangeably herein) in hydraulic jacking and lifting structures, that provides a warning to the user sufficiently prior to an actual overload condition. As a result, the user can remedy the pressure situation in the jacking or lifting structure well before an actual overload and failure. Additionally, the user is made aware of the jack heading toward an overload condition, well before such condition and may receive multiple warnings as to the oncoming overload condition, as the jack approaches capacity, and the actual overload condition, that the jack has reached capacity. As a result, the user knows that the jacking structure is not defective, but rather, the load on the jacking structure is approaching, at, or above safe capacity.

The system of the disclosed subject matter is such that it utilizes pressures of the fluid displaced from the pump, from the displacement strokes, to detect unsafe, potentially unsafe conditions, such as overloads of the jack, at times sufficiently prior to the overload condition being reached. This detection results in a visual, audible, or tactile alarm activating in sufficient time for the user to take action in potentially dangerous situations.

An embodiment of the disclosed subject matter is directed to a warning system for hydraulic jacks, for example, for warning of an overload or potential overload, that the jack or lifting apparatus that employs the system is at lifting capacity. The system includes a high pressure line through which fluid is delivered to the pressure chamber of the jack from a pump, and the pressure chamber houses a moveable piston therein, which serves to lift the load. There is a one way valve along the high pressure line for permitting fluid flow from the pump to the pressure chamber, that restricts fluid flow from the pressure chamber back to the pump. The one way valve divides the high pressure line into a first segment, coupling the pump to the one way valve, and a second segment, coupling the one way valve to the pressure chamber. There is a safety line coupled with the pump and a drain, for example, a reservoir, and the safety line provides a fluid pathway for relieving pressure in at least the pressure chamber.

A safety valve is along the safety line, and there is a fluid pressure sensor coupled with at least one of the first segment of the high pressure line or the safety line. There is also an indicator coupled with the fluid pressure sensor, for producing an indication when signaled by the fluid pressure sensor upon the fluid pressure sensed by the fluid pressure sensor reaching at least a pressure preset in the fluid pressure sensor. The indicator produces at least one indication, that may be visible, for example, a Light Emitting Diode (LED) or other light activation or flash, audible, for example, sound, or tactile, for example, a vibration. Upon becoming aware of the indication, by seeing, hearing or feeling it, the user can attend to the high pressure situation in the jack and work to relieve it.

### BRIEF DESCRIPTION OF THE DRAWINGS

Attention is now directed to the drawing figures, wherein like reference numerals or characters indicate corresponding or like components. In the drawings:

FIG. 1 is cross-sectional view of the system of the disclosed subject matter in use with a hydraulic jack;

FIG. 2 is hydraulic schematic diagram of the system of FIG. 1;

FIG. 3 is cross-sectional view of an alternate system of the disclosed subject matter in use with a hydraulic jack; and,

FIG. 4 is hydraulic schematic diagram of the system of FIG. 3;

### DETAILED DESCRIPTION

In this document, references are made to jacks 20 and 120, in which the disclosed subject matter is employed, for example. These jacks 20, 120 include numerous hydraulic lines and connections. The hydraulic lines, connections and the like, shown in the drawing figures and described below include those necessary to show the disclosed subject matter in its structure and operation, in the exemplary jacks 20, 120 and their corresponding schematic diagrams, detailed below.

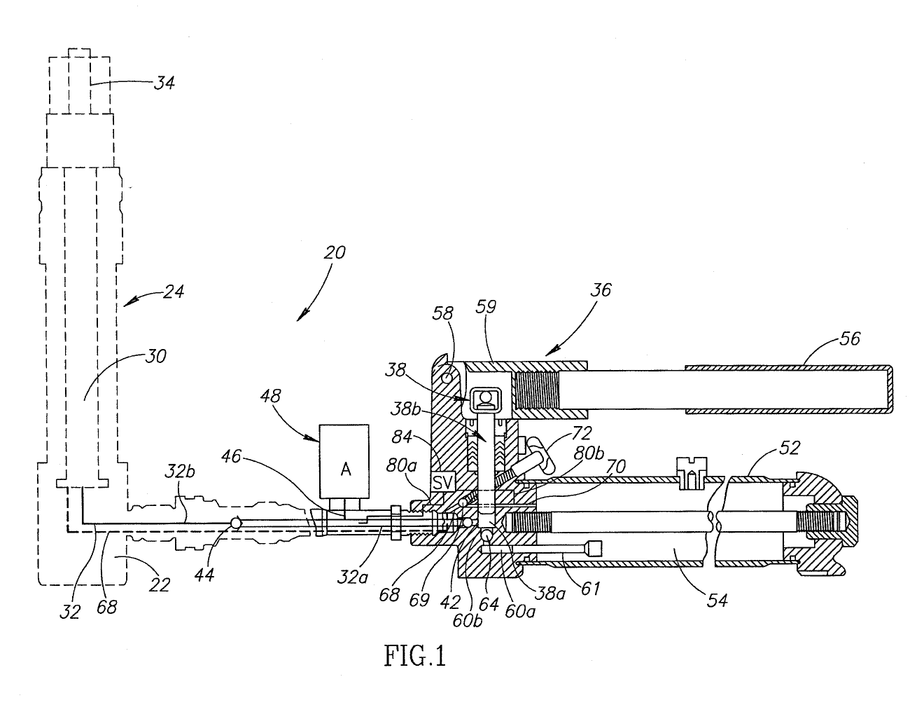

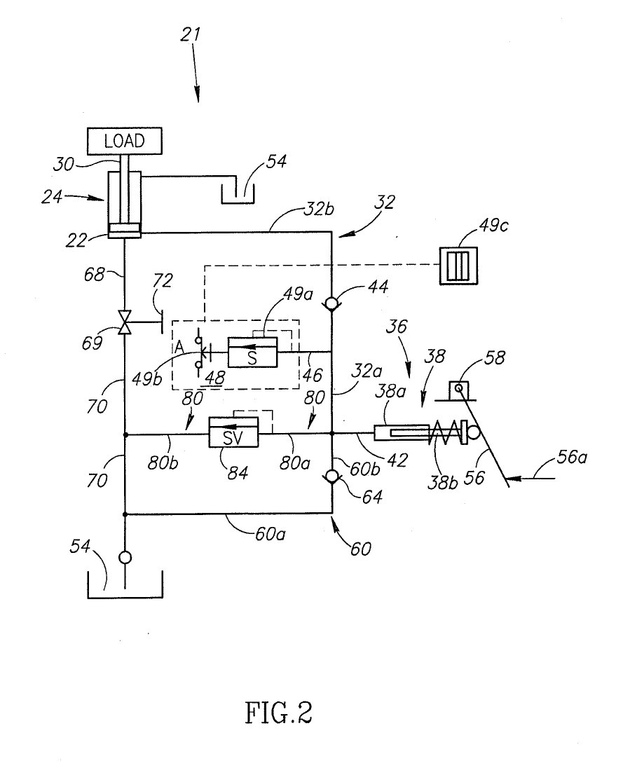

FIG. 1 shows an example jack 20, in which the disclosed subject matter may be employed. FIG. 2 is the hydraulic schematic diagram of a system 21, employed, for example, in the corresponding jack 20, and attention is also directed to this diagram.

The jack 20 includes a pressure chamber 22 formed of an outer cylinder 24, that houses a movable piston 30, movable by fluid flow into the pressure chamber 22 from a high-pressure line 32. A ram 34, that contacts the load, is connected to the piston 30. Fluid flow is forced into the pressure chamber 22 from a pump unit 36, that includes a pump 38, pump cavity 38a, and a pump piston 38b that moves (also known as displacing) fluid out of the pump cavity 38a.

The pressure chamber 22 is supplied with fluid (known also as oil, hydraulic fluid, hydraulic oil, and the like) from the pump 38. The pump 38 receives the fluid in its pump chamber 38a and sends (moves or displaces) the fluid over a line 42 into the high pressure line 32. A valve 44 is along the high pressure line 32, between the segments 32a, 32b. An alarm line 46 extends from the high pressure line segment 32a upstream of the valve 44, that extends into contact with an alarm (A) 48. In this document, references are made to the terms “upstream” and “downstream” and accordingly, the referenced flow originates (upstream) at the pump 38, or alternately, the reservoir 54 with fluid drawn into the pump 38 through the low pressure line 60, and ends (downstream) at the pressure chamber 22 or reservoir 54.

The valve 44 is, for example, a one-way valve and a high pressure valve, such as a ball check valve. The valve 44 allows the pressure chamber 22 to maintain its pressure, and it prevents fluid from flowing back to the pump 38, especially on the suction stroke of the pump 38 (e.g., the pump piston 38b in the pump cavity 38a).

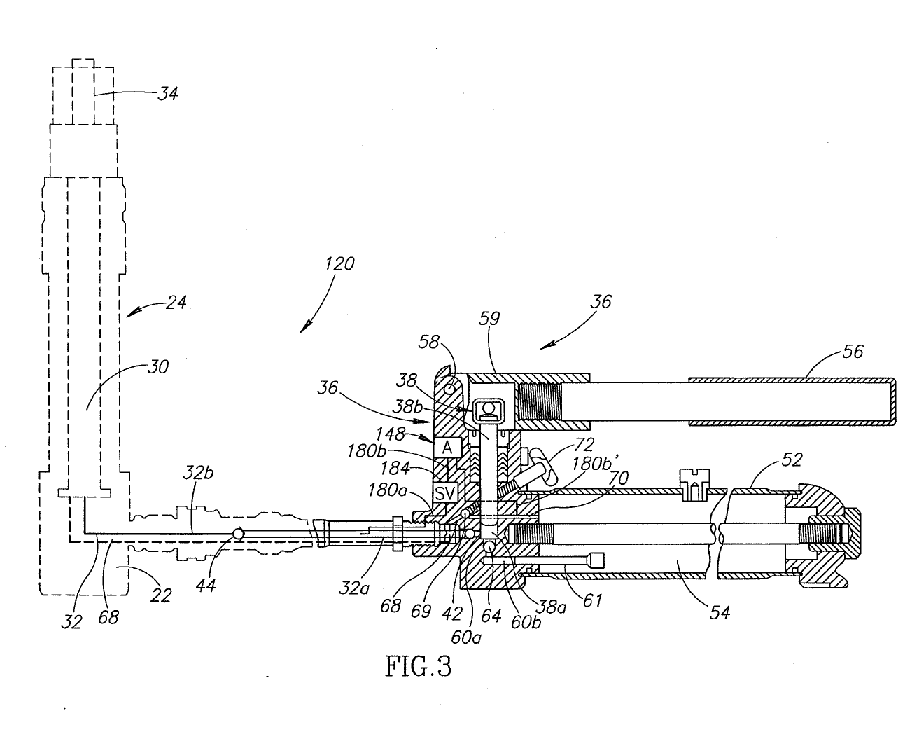

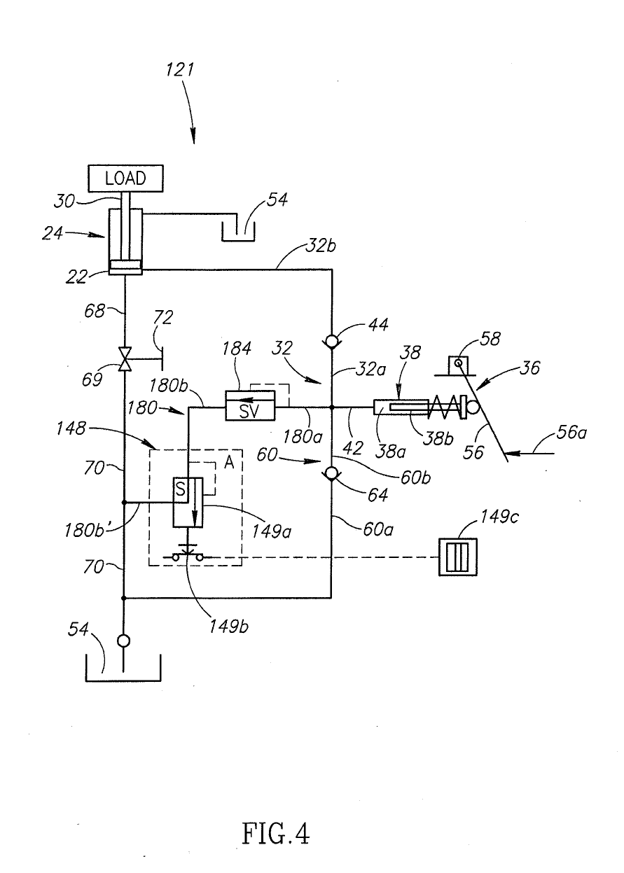

In further explaining the disclosed subject matter, reference is made to an overload condition, where the load on the piston 30 causes the pressure of the fluid to exceed the intended operating pressure of the jack 20. In terms of the jack 20 and its associated system 21 in the schematic of FIG. 2 (also applicable to the jack 120 and its associated system 121, shown in FIGS. 3 and 4 and detailed below), an overload condition is reached when the piston 30 is no longer moving upward, when fluid is being pumped into the pressure chamber 22. As a result, the volume of the pressure chamber 22 and high pressure line segment 32b is no longer increasing, to accommodate the fluid that continues to be pumped (moved or displaced) into the pressure chamber 22 and the high pressure line segment 32b from the pump 38. This causes the pressure in the high pressure line segment 32b to build up, holding the valve 44 closed, such that fluid being pumped can no longer enter the high pressure line segment 32b downstream of the valve 44. The valve 44 may also be rated or preset to close at pressures not greater than the pressure of the overload condition (the pressure associated with operating capacity of the respective jacks 20, 120).

The alarm (A) 48 includes a fluid pressure sensor (S) 49a, electronically linked (for example, wired or wirelessly) to a switch 49b, that is electronically linked (for example, wired or wirelessly) to a light mechanism 49c (e.g., LED or the like) and/or other mechanism, such as sound, vibration, etc. The fluid pressure sensor (S) 49a may be a conventional pressure sensor, such as an electromagnetic sensor, or the like, and, for example, may be a Ronald® Model PC312 from Ronald of Taiwan (www.ronald.com.tw).

The pump unit 36 includes a cylinder 52 that serves as a fluid reservoir 54. The pump 38 is actuated by a pivotally attached handle 56 at a joint 58. A user pumps (applies force) the handle 56 as represented by the arrow 56a. The handle 56 screws into a yoke 59, that attaches to the pump unit 36 at the joint 58. The pump 38 draws fluid from the reservoir 54, into the pump cavity 38a (via the low pressure line 60), and the piston 38b displaces the fluid, moving or sending it to the pressure chamber 22 over the high pressure line segments 32a, 32b. The pump 38 receives fluid from the reservoir 54, through a low pressure line 60, formed of segments 60a, 60b (segment 60a, for example, including an intake tube 61, with a filter or the like), with a one-way valve 64 positioned between the line segments 60a, 60b.

A branch line 68 extends from the pressure chamber 22 to a valve 69, that is biased in a closed position. A relief line 70 extends from the valve 69 to the reservoir 54. The valve 69 is actuated by a lever 72, that when pulled outward (manually), such that the biasing force is overcome, opens, allowing fluid in the pressure chamber 22 and/or branch line 68, to flow into the relief line 70 and into the reservoir 54, relieving the high pressure in the pressure 22 chamber, high pressure line segment 32b, and the branch line 68.

A safety line 80, formed of segments 80a, 80b extends from the high pressure line segment 32a to a safety valve 84 to the relief line 70. The safety valve (SV) 84 is, for example, a standard valve, rated to open at a pressure not higher than the pressure of the overload condition, in order to allow the alarm (A) 48, to activate, as the alarm (A) 48 is set to activate at pressures less than or equal to the opening pressure for the safety valve (SV) 84. The alarm (A) 48 may be such that it will provide repeated warnings until the pressure decreases beyond a preset amount. Additionally, the alarm (A) 48 may be set to shut off when the pressure has fallen to the activation preset pressure or a preset pressure below the activation preset pressure. When the safety valve (SV) 84 opens, pumped fluid is sent to the reservoir 54 through the relief line 70 (over the safety line segments 80a, 80b).

Additionally, when the potential overload or overload situation has been relieved, for example, the pressure decreasing by a predetermined amount, the fluid pressure sensor 49a will also signal the switch 49b, such that the light 49c shuts off (as well as any sound or the like), as the pressure in the high pressure line 32 has been relieved. Similarly, the safety valve (SV) 84 closes due to low pressure (for example, as preset in the safety valve (SV) 84, for example, the preset opening pressure or slightly less than the preset opening pressure) in the safety line segment 80a.

Staying in FIG. 2, the hydraulic schematic will be used in explaining the standard or normal condition and the overload condition, or a condition prior to an overload, that sets off the alarm (A) 48, warning the user of the overload or potential overload condition.

Valves 44 and 64 are one-way valves, and, for example, are ball check valves. These ball check valves 44, 64 both include a ball that rests on a seat (the open portion of the “V”) when the valves 44, 64 are closed by pressure in the respective line segments 32b, 60a. Valve 44 is along the high pressure line 32, between the segments 32a, 32b and is biased to allow fluid to flow from the pump 38 into the pressure chamber 22. Valve 64 is along the low pressure line 60, between the segments 60a, 60b, and is biased, to allow fluid to flow from the reservoir 54 to the pump 38 (during a suction stroke of the pump 38), but the suctioned (drawn) fluid is blocked by the valve 64 from returning to the reservoir 54. The valve 44, for example, remains closed or partially closed, restricting fluid flow into the pressure chamber 22, based on the pressure in the high pressure line segment 32b. This high pressure condition causes the alarm (A) 48 to activate prior to an actual overload, at predetermined pressures, set (preset) in the alarm (A) 48, for purposes of safety, as detailed below.

The safety line 80, formed of segments 80a, 80b, extends from the- high pressure line segment 32a to a safety valve (SV) 84 to the relief line 70. The safety valve (SV) 84 is preset or rated at pressures that will cause it to open, that are equal to or lower than the overload pressure. Upon opening of the safety valve (SV) 84, fluid is pumped back into the reservoir 54 through the relief line 70 (via the safety line segments 80a, 80b), so that the pressure does not continue to build in the high pressure line segment 32b.

In normal operation, initially, the pressure chamber 22, and all of the lines 32, 42, 46, 60, 68, 70 and 80 of the system 21, are filled with fluid. The pump 38 obtains fluid, from the reservoir 54, via a suction stroke, and delivers the fluid to the pressure chamber 22, along the high pressure line segments 32a, 32b, by a displacement stroke. This succession of pumping strokes is repeated, filling the pressure chamber 22 and moving the piston 30 and subsequently, the ram 34 upward, until the load is lifted to the desired height.

When the load is at its desired height, and the jack 20 may be returned to its initial position, the lever 72 is pulled outward, and the fluid in the pressure chamber 22 returns to the reservoir 54 (through lines 68 and 70). The safety valve (SV) 84 remains closed.

In the overload condition or just prior to the overload condition being reached, the pump 38 delivers fluid from the reservoir 54 to the pressure chamber 22, along the high pressure line 32, but the pressure in the high pressure line segment 32b is increasing. This is because the piston 30 is not lifting, for example, due to the force of the load on the piston 30. The pressure chamber 22 is now of a finite volume. The back pressure from the pressure chamber 22 in the high pressure line segment 32b (as the pressure chamber 22 maintains its pressure) forces the valve 44 closed, keeping the ball against its seat.

With the valve 44 closed, the displacement stroke of the pump 38, forces fluid into line segment 32a, lines 42, 46, segment 60b and segment 80a, causing increased pressure in these lines, and line segments, respectively. The pumped (displaced) fluid that flows into the alarm line 46, and if at a pressure at least at the preset pressure of the sensor (S) 49a, activates the alarm (A) 48. Activation of the alarm (A) 48 (for example, by illumination of the LED 49c or an audible indicator), serves to warn the user of a potential overload condition or an overload condition (depending on the preset activation pressures in the alarm (A) 48 and safety valve (SV) 84, respectively), and to stop the jacking operation immediately.

Within the safety line segment 80a, if the pressure has increased to the pressure preset in the safety valve (SV) 84 to open it, the safety valve (SV) 84 being preset, for example, to pressures greater than the pressure sensor (S) 49a, but not higher than the pressure of the overload condition, the safety valve (SV) 84 opens. Fluid then flows through safety line segment 80b, into the relief line 70 and to the reservoir 54, relieving the high pressure condition. This fluid flow path, from the pump cavity 38a, through the line 42 to the safety line segments 80a, 80b, and through the relief line 70 to the reservoir continues for all subsequent displacement pump strokes and resultant fluid displacement, until the pressure in the pressure chamber 22 and high pressure line segment 32b, caused by the load, is reduced below the preset pressure of the safety valve (SV) 84 (for example, causing the safety valve (SV) 84 to close). A potentially dangerous condition has been detected prior to an actual overload condition being reached in the jack 20.

Alternately, the user, if aware of the overload or potential overload, may pull the lever 72, to open the valve 69 to alleviate the high pressure in the pressure chamber 22 and the high pressure line 32, in line segment 32b. The high pressure of an overload or potential overload is alleviated, as the manually displaced lever 72 opens the valve 69, such that fluid flows into the relief line 70 and into the reservoir 54. Should the fluid pressure be relieved to pressures below the preset pressure of the safety valve (SV) 84, the safety valve (SV) 84 will remain closed, or close if open, and the alarm (A) 48, if active or on, will shut off. The user can attend to the situation.

FIG. 3 shows an example jack 120, in which the disclosed subject matter may be employed. This jack 120, is such that like or similar components to those components of the jack 20 in shown in FIGS. 1 and 2 above, are numbered identically. The descriptions for these components of the jack 20, as discussed above, are applicable to the jack 120 of FIGS. 3 and 4 and detailed below. Different components are discussed below. FIG. 4 is the hydraulic schematic diagram of a system 121, employed, for example, in the corresponding jack 120, and attention is also directed to this diagram.

In the jack 120, the alarm (A) 148 and its components 149a-149c, are similar to the alarm (A) 48 and its components 49a-49c, detailed above. The alarm (A) 148 is similar in its positioning to the alarm (A) 48, in that it is also upstream of the valve 44 in the high pressure line 32. The alarm (A) 148 is positioned along on the safety line 180, between the line segments 180b, 180b′ downstream of the safety valve (SV) 184 (similar to safety valve (SV) 84 detailed above). The safety line 180 for this jack 120 is formed by segments 180a, 180b and 180b′.

The safety valve (SV) 184, receives fluid (displaced by the pump 38) through safety line segment 180a (from line 42). The safety valve (SV) 184 is, for example, rated or preset to open at a pressure less than but not higher than the pressure of the overload condition. The alarm (A) 148 is preset to activate at pressures equal to or less than the opening pressure for the safety valve (SV) 184. Opening of the safety valve (SV) 184 allows the fluid to flow (along segment 180b) through the sensor (S) 149a, at pressures equal to or greater than the preset pressures for the pressure sensor (S) 149a of the alarm (A) 148. This causes the alarm (A) 148 to activate. The fluid flows through the sensor (S) 149a of the alarm (A) 148, into the final safety line segment 180b′, into the relief line 70, through which it reaches the reservoir 54.

In normal operation, initially, the pressure chamber 22, and all of the lines 32, 42, 60, 68, 70 and 180 of the system 121, are filled with fluid. As discussed above, the pump 38 obtains fluid, from the reservoir 54, via a suction stroke, and delivers the fluid to the pressure chamber 22, along the high pressure line segments 32a, 32b, by a displacement stroke. This succession of pumping strokes is repeated, filling the pressure chamber 22 and moving the piston 30 and subsequently, the ram 34 upward, until the load is lifted to the desired height.

When the load is at its desired height, and the jack 120 may be returned to its initial position, the lever 72 is pulled outward, and the fluid in the pressure chamber 22 returns to the reservoir 54 (through lines 68 and 70). The safety valve (SV) 184 remains closed. Accordingly, the alarm (A) 148 remains off.

In the overload condition or just prior to the overload condition being reached, the pump 38 delivers fluid from the reservoir 54 to the pressure chamber 22, along the high pressure line 32. However, as discussed above, the pressure in the high pressure line segment 32b is increasing, as the piston 30 is not lifting, for example, due to the force of the load on the piston 30. The pressure chamber 22 is now of a finite volume. The backpressure from the pressure chamber 22 in the high pressure line segment 32b (as the pressure chamber 22 maintains its pressure) forces the valve 44 closed, keeping the ball against its seat.

With the valve 44 closed, the displacement stroke of the pump piston 38b, forces fluid into line 42, line segment 32a, segment 60b, and safety line segment 180a. Within the safety line segment 180a, if the pressure has increased to the pressure preset in the safety valve (SV) 184 to cause it to open, the preset pressures less than or at the pressure of the overload condition, the safety valve (SV) 184 opens. Fluid then flows into the safety line segment 180b.

The fluid flowing in the safety line segment 180b remains, or is slightly less than the pressure when the safety valve (SV) 184 opened, and now flows through the sensor (S) 149a of the alarm (A) 148. As stated above, the sensor 149a is set to activate the alarm components 148b, 148c, when it senses fluid at its preset pressure, that is equal to or less than the preset pressure of the safety valve (SV) 184. For example, the preset pressure for the sensor (S) 149(a) may be slightly less than the preset pressure of the safety valve (SV) 184, to compensate for any pressure changes in the fluid resulting from relief from the aforementioned opening of the safety valve (SV) 184. Activation of the alarm (A) 148 (for example, by illumination of the LED 149c or an audible indicator), serves to warn the user of an overload, and to stop the jacking operation immediately.

Once past the sensor (S) 149a, the fluid flows into the safety line segment 180b′, into the relief line 70 and to the reservoir 54, relieving the high pressure condition. This fluid flow path, from the pump cavity 38a, through the line 42 to the safety line segments 180a, 180b, 180b′ and through the relief line 70 to the reservoir 54 continues for all subsequent displacement pump strokes and the resultant fluid displacements, until the pressure in the pressure chamber 22 and high pressure line segment 32b, caused by the load, is reduced below the preset pressure of the safety valve (SV) 184 (for example, causing the safety valve (SV) 184 to close). A potentially dangerous condition has been detected prior to an actual overload condition being reached in the jack 20.

Alternately, as discussed above, the user, if aware of the overload or potential overload, may pull the lever 72, to open the valve 69 to alleviate the high pressure in the pressure chamber 22 and the high pressure line 32, in line segment 32b. The high pressure of an overload or potential overload is alleviated, as the manually displaced lever 72 opens the valve 69, such that fluid flows into the relief line 70 and into the reservoir 54. Should the fluid pressure be relieved to pressures below the preset pressure of the safety valve (SV) 184, the safety valve (SV) 184 will remain closed, or close if open, and the alarm (A) 148, if active or on, will shut off. The user can attend to the situation.

While preferred embodiments have been described, so as to enable one of skill in the art to practice the disclosed subject matter, the preceding description is intended to be exemplary only. It should not be used to limit the scope of the disclosed subject matter, which should be determined by reference to the following claims.

What is claimed is:

1. A warning system for hydraulic jacks, comprising:
a high pressure line through which fluid is delivered to the pressure chamber of the jack from a pump, and the pressure chamber houses a moveable piston therein;
a one way valve along the high pressure line for permitting fluid flow from the pump to the pressure chamber but restricting fluid flow from the pressure chamber back to the pump, the one way valve dividing the high pressure line into a first segment, in communication with the pump, and a second segment in communication with the pressure chamber;
a safety line in communication with the pump and a drain, the safety line providing a fluid pathway for relieving pressure in at least the pressure chamber;
a safety valve along the safety line; and
a fluid pressure sensor in communication with at least one of the first segment of the high pressure line or the safety line.

2. The warning system of claim 1, wherein the safety valve opens at a preset fluid pressure less than the pressure associated with capacity of the jack, the capacity of the jack defining an overload condition.

3. The warning system of claim 1, wherein the drain includes a reservoir.

4. The warning system of claim 2, wherein the fluid pressure sensor is on a fluid line connected to the first segment of the high pressure line.

5. The warning system of claim 4, additionally comprising an indicator in communication with the fluid pressure sensor for producing an indication when signaled by the fluid pressure sensor upon the fluid pressure sensed by the fluid pressure sensor reaching at least a pressure preset in the fluid pressure sensor.

6. The warning system of claim 5, wherein the indicator produces at least one of a visible, audible or tactile indication.

7. The warning system of claim 5, wherein the preset pressure in the fluid pressure sensor is not greater than the preset pressure of the safety valve.

8. The warning system of claim 2, wherein the fluid pressure sensor is on a fluid line connected to the safety line between the safety valve and the drain.

10. The warning system of claim 8, additionally comprising: an indicator in communication with the fluid pressure sensor for producing an indication when signaled by the fluid pressure sensor upon the fluid pressure sensed by the fluid pressure sensor reaching at least a pressure preset in the fluid pressure sensor.

11. The warning system of claim 9, wherein the indicator produces at least one of a visible, audible or tactile indication.

12. The warning system of claim 9, wherein the preset pressure in the fluid pressure sensor is less than or equal to the preset pressure of the safety valve.
